(19) United States
(12) Patent Application Publication
(10) Pub. No.: US 2016/0125544 A1
(43) Pub. Date: May 5, 2016

(54) SYSTEM FOR WORKERS' COMPENSATION CLAIM PROCESSING

(71) Applicant: Hartford Fire Insurance Company, Hartford, CT (US)

(72) Inventors: Paul J. Edwards, West Hartford, CT (US); Keren Shemesh, West Hartford, CT (US); Gary S. Tomchik, The Woodlands, TX (US)

(21) Appl. No.: 14/641,760

(22) Filed: Mar. 9, 2015

Related U.S. Application Data
(60) Provisional application No. 62/074,367, filed on Nov. 3, 2014.

(51) Int. Cl. G06Q 40/08; G06Q 10/10

(52) U.S. Cl. CPC G06Q 40/08; G06Q 10/1057

(57) ABSTRACT

According to some embodiments, data may be received indicative of a plurality of insurance claims along with an indication of location for each insurance claim. A first workers' compensation benefit rule may then be determined for a first workers' compensation insurance claim associated with a first location. Similarly, a second workers' compensation benefit rule (different from the first workers' compensation benefit rule) may be determined for a second workers' compensation insurance claim associated with a second location. A first benefit amount and a second benefit amount may then be automatically calculated for the workers' compensation insurance claims based on the rules and application of appropriate waiting period and retroactive period rules. Reconciliation values may be automatically displayed, and indications of the first and second benefit amounts may be transmitted.

### CROSS-REFERENCE TO RELATED APPLICATIONS

The present claims the benefit of U.S. Patent Application No. 62/074,367 entitled “Systems for Workers' Compensation Claim Processing” filed Nov. 3, 2014. The entire content of that application is incorporated herein by reference.

### FIELD

The present invention relates to computer systems and more particularly to computer systems that provide an automated workers' compensation claim processing system.

### BACKGROUND

An insurer may provide payments when claims are made in connection with an insurance policy. For example, an employee who is injured while working might receive payments associated with a workers' compensation insurance policy purchased by his or her employer. The insurer may assign a claim handler to communicate with a claimant, an employer, another insurer, and/or medical service providers to help determine the appropriate amount of payment. Note that different locations may be associated with different workers' compensation rules, laws, and/or regulations. For example, California might require that workers receive at least a weekly minimum payment value while New York requires that workers receive at least a different value per week.

In some cases, a jurisdiction may penalize an insurer for providing an inappropriate benefit amount in connection with a workers' compensation insurance claim. Typically, a claim handler working for an insurer may utilize several different systems and/or manuals to review a workers' compensation insurance claim and applicable jurisdiction-based requirements to determine an appropriate benefit amount for a claimant. For example, a claim handler might need to access a human resource system, an accounting application, an insurance policy database, a jurisdiction-based manual of rules, a payment platform, etc. to determine an appropriate benefit amount. Moreover, using these different systems to determine the benefit amounts can be a time consuming and error prone task, especially when there are a substantial number of claims, of many different types and/or from many different locations, to be processed. For example, an insurer might receive tens of thousands of new workers' compensation insurance claims each year (which might represent a substantial potential liability if benefit amounts are not correctly determined). It would therefore be desirable to provide systems and methods to facilitate the processing of workers' compensation insurance claims in an automated, efficient, and accurate manner.

### SUMMARY

According to some embodiments, systems, methods, apparatus, computer program code and means may facilitate the processing of workers' compensation insurance claims. In some embodiments, data may be received indicative of a plurality of insurance claims along with an indication of location for each insurance claim. A first workers' compensation benefit rule may then be determined for a first workers' compensation insurance claim associated with a first location. Similarly, a second workers' compensation benefit rule (different from the first workers' compensation benefit rule) may be determined for a second workers' compensation insurance claim associated with a second location. A first benefit amount and a second benefit amount may then be automatically calculated for the workers' compensation insurance claims based on the rules and application of waiting period and retroactive period rules. Reconciliation values may be automatically displayed, and indications of the first and second benefit amounts may be transmitted.

A technical effect of some embodiments of the invention is an improved and computerized method for processing and/or providing payments associated with workers' compensation insurance claims. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is block diagram of a system according to some embodiments of the present invention.

FIG. 2 illustrates a method that might be performed in accordance with some embodiments.

FIG. 3 is block diagram of a workers' compensation insurance claim processing system according to some embodiments of the present invention.

FIG. 4 is an example of a method that might be performed according to some embodiments.

FIGS. 5 through 7 illustrate workers' compensation parameters displays in accordance with some embodiments.

FIG. 8 is an indemnity summary display that may be provided according to some embodiments.

FIG. 9 illustrates a loss time/work status display in accordance with some embodiments.

FIG. 10 is an indemnity benefits display that may be provided according to some embodiments.

FIG. 11 illustrates a wizard waiting period display in accordance with some embodiments.

FIG. 12 is a wizard payment display that may be provided according to some embodiments.

FIG. 13 illustrates a wizard benefit reconciliation details display in accordance with some embodiments.

FIG. 14 is a wizard benefit reconciliation summary display that may be provided according to some embodiments.

FIGS. 15 through 24 illustrate displays of waiting period and retroactive period examples in accordance with some embodiments.

FIG. 25 is block diagram of a workers' compensation reconciliation tool or platform according to some embodiments of the present invention.

FIG. 26 is a tabular portion of a workers' compensation insurance claim database according to some embodiments.

FIG. 27 illustrates a tablet computer displaying information about a workers' compensation insurance claim processing system in accordance with some embodiments.

### DETAILED DESCRIPTION

An insurer may provide payments when claims are made in connection with workers' compensation insurance policies. Note that some embodiments may be associated with an insurance claim process system that is also able to process other types of insurance, including automobile insurance, long term disability insurance, short term disability insurance, flexible combinations of short and long term disability insurance, homeowners insurance, property insurance, general liability insurance, and/or commercial insurance.

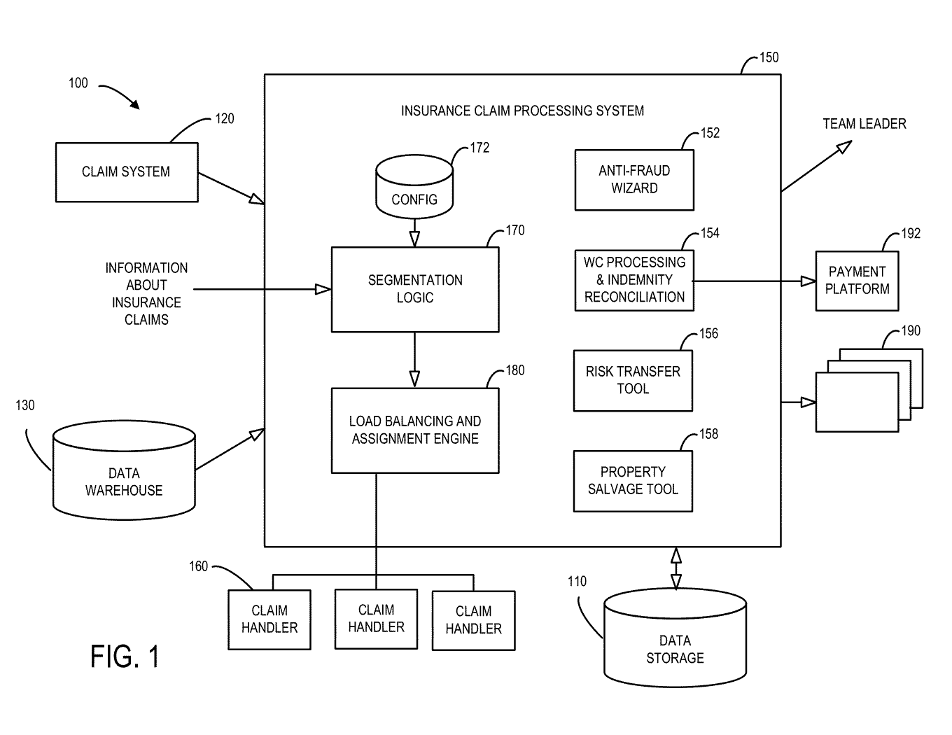

Using multiple computer systems and databases (which might not be able to directly communication with each other) and/or manuals to determine appropriate benefit amounts for workers' compensation insurance claims can be time consuming and difficult task, especially when there are a substantial number of claims, of many different types and/or from many different locations, to be processed. It would therefore be desirable to provide systems and methods to facilitate the processing of workers' compensation insurance claims. FIG. 1 is block diagram of a system 100 according to some embodiments of the present invention. In particular, the system 100 includes an insurance claim processing system 150 that receives information about insurance claims (e.g., by receiving an electronic file from a team leader, an employer, an employee, an insurance agent, a medical service provider, or a data storage unit 110). According to some embodiments, incoming telephone calls and/or documents from a doctor may be used to create information in a claim system 120 which, in turn, can provide information to the insurance claim processing system 150. In other embodiments, the insurance claim processing system 150 may retrieve information from a data warehouse 130 (e.g., when the insurance claim processing system 150 is associated with an automobile insurance system, some information may be copied from an automobile insurance data warehouse). In other embodiments, some or all of the information about an insurance claim may be received via a claim submission process.

The insurance claim processing system 150 may, according to some embodiments, include segmentation logic 170 that automatically determines an appropriate segment (e.g., based on the likely complexity or liability) for insurance claims (e.g., in accordance with customizable configurations parameters 172). This segmentation information may then be used by a load balancing and assignment engine 180 to select an appropriate claim handler 160 for each insurance claim. According to some embodiments, historical information may be used to generate appropriate segmentation and/or claim assignment rules to be applied based on the specific facts of the insurance claim being processed.

The insurance claim processing system 150 might be, for example, associated with a Personal Computers (PC), laptop computer, an enterprise server, a server farm, and/or a database or similar storage devices. The insurance claim processing system 150 may, according to some embodiments, be associated with an insurance provider.

According to some embodiments, an “automated” insurance claim processing system 150 may facilitate the assignment of insurance claims to appropriate segments and/or claim handlers 160. For example, the insurance claim processing system 150 may automatically output a recommended claim segment for a received insurance claim (e.g., indicating that the insurance claim belongs in a “high exposure” segment) which may then be used to facilitate assignment of a claim handler 160. As used herein, the term “automated” may refer to, for example, actions that can be performed with little (or no) intervention by a human. Moreover, any of the embodiments described herein may be “dynamically” performed by monitoring parameters and/or automatically updating outputs in substantially real time.

As used herein, devices, including those associated with the insurance claim processing system 150 and any other device described herein, may exchange information via any communication network which may be one or more of a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network, and/or an Internet Protocol (IP) network such as the Internet, an intranet, or an extranet. Note that any devices described herein may communicate via one or more such communication networks.

The insurance claim processing system 150 may store information into and/or retrieve information from the data storage 110. The data storage 110 might be associated with, for example, a client, an employer, or insurance policy and might store data associated with past and current insurance claims and/or payments. The data storage 110 may be locally stored or reside remote from the insurance claim insurance claim processing system 150. As will be described further below, the data storage 110 may be used by the insurance claim processing system 150 to generate predictive models. According to some embodiments, the insurance claim processing system 150 communicates a recommended claim processing workflow (e.g., expedited or normal workflows), such as by transmitting an electronic file to a claim handler 160, a client device, an insurance agent or analyst platform, an email server, a workflow management system, a payment facilitation device (e.g., to send checks to claimants), etc. In other embodiments, the insurance claim processing system 150 might output a recommended claim workflow indication to a team leader who might select a claim handler based on that indication or override the indication based on other factors associated with the insurance claim.

According to some embodiments, the insurance claim processing system 150 further includes an anti-fraud wizard 152 (e.g., to help detect inappropriate insurance claims), a Workers' Compensation (“WC”) indemnity reconciliation and processing tool 154 (e.g., to help a claim handler 160 comply with various jurisdiction based regulations), a risk transfer tool 156 (e.g., to help identify other parties who may have liability in connection with an insurance claim), and/or a property salvage tool 158 (e.g., to help identify situations where value may be identified and/or obtained in connection with an insurance claim). Moreover, the insurance claim processing system 150 may transmit information to other devices 190 or applications, such as email servers, report generators, calendar applications, etc. According to some embodiments, the WC indemnity reconciliation and processing tool 1544 may further output information about an appropriate benefit amount to a payment engine 192 (e.g., which may also be associated with one or more accounting applications). The payment engine 192 might, for example, automatically arrange for funds to be placed in a claimant's bank account and/or generate a physical check that is automatically mailed to an address associated with a claimant. Note that at least some of the tool and other applications associated with the insurance claim processing system 150 might be incorporated within, or utilize, an electronic spreadsheet, such as the EXCEL® electronic spreadsheet program available from MICROSOFT®. According to other embodiments, at least some of the tool and other application associated with the claim processing system 150 might comprise a stand-alone software application.

Although a single insurance claim processing system 150 is shown in FIG. 1, any number of such devices may be included. Moreover, various devices described herein might be combined according to embodiments of the present invention. For example, in some embodiments, the insurance claim processing system 150 and data storage 110 might be co-located and/or may comprise a single apparatus.

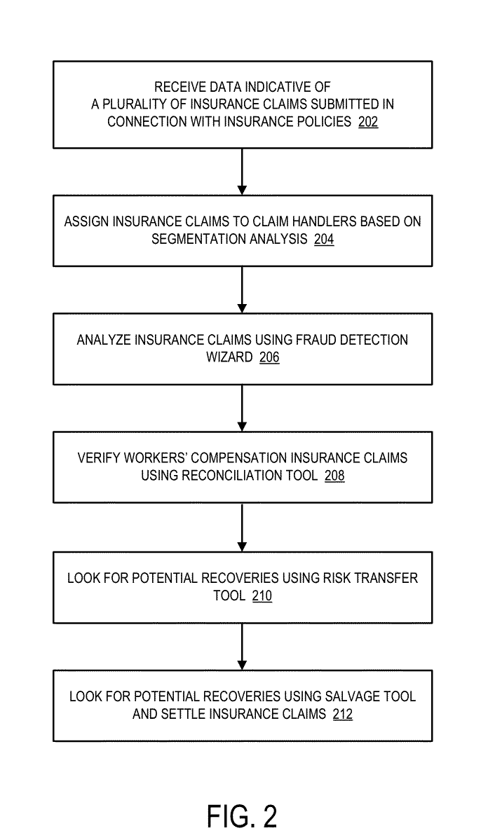

FIG. 2 illustrates a method that might be performed by some or all of the elements of the system 100 described with respect to FIG. 1 according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At 202, data may be received indicative of a plurality of insurance claims submitted in connection with insurance policies. The insurance claims might be associated with, for example, workers' compensation insurance claims and/or automobile insurance claims. Note that the data indicative of insurance claims might be received via submitted paper claims, a telephone call center, and/or an online claim submission web site.

At 204, insurance claims may be assigned to claim handlers based, at least in part, on a segmentation analysis. For example, an insurance claim might be recognized as requiring highly complex handling (e.g., a claim identified as a “longshore” claim) and thus be assigned to a “specialized” segment. As a result, the claim may be assigned to a particular group of claim handlers who have experience with these types of insurance claims.

At 206, insurance claims may be analyzed using a fraud detection wizard. The fraud detection wizard may, for example, look for suspicious information, patterns, or values within one or more insurance claims (which, when found, may prompt further investigation. At 208, workers' compensation insurance claims may be verified using a reconciliation tool. For example, different jurisdictions may have different recordkeeping requirements and/or penalties associated with workers' compensation claims and the reconciliation tool may help claim handlers process such claims in an appropriate manner. At 210, embodiments may look for potential recoveries using a risk transfer tool. According to some embodiments, the risk transfer tool might identify other parties (e.g., other insurance companies, employers, etc. who might be liable for at least a portion of the payments associated with an insurance claim). At 212, embodiments may look for potential recoveries using a salvage tool (e.g., the salvage value associated with an automobile accident) and the insurance claims may be settled.

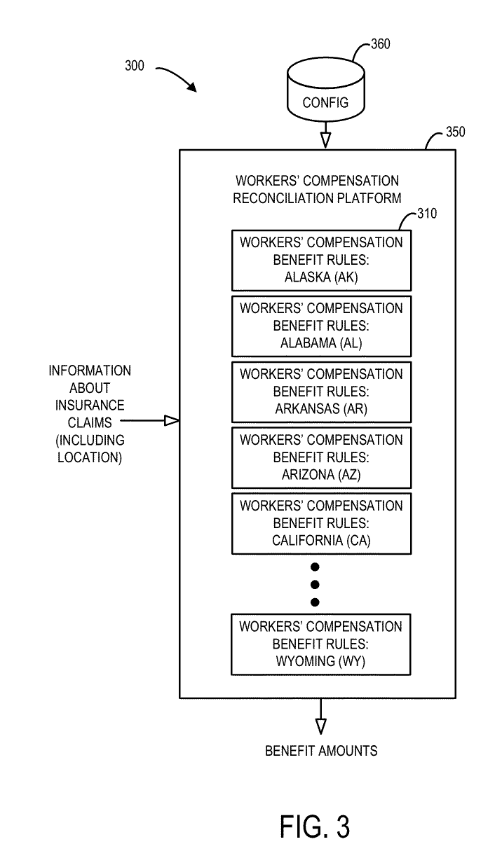

FIG. 3 is block diagram of a workers' compensation insurance claim reconciliation system 300 according to some embodiments of the present invention. The reconciliation system 300 includes a workers' compensation reconciliation platform 350 which may be associated with the WC indemnity reconciliation tool 154 described with respect to FIG. 1. According to some embodiments, the workers' compensation reconciliation platform 350 automatically determines appropriate benefit amounts (e.g., based on details of the work injury) for insurance claims (e.g., in accordance with customizable configurations parameters 360). This benefit amount may then be transmitted and/or displayed to an appropriate claim handler for each insurance claim. Note that different locations may be associated with different workers' compensations rules and regulations. For example, as illustrated in FIG. 3, a workers' compensation insurance claim may be processed using workers' compensation benefit rules 310 based on the state associated with that claim (e.g., a claim arising from an injury in Alaska may be associated with different minimum and maximum benefit values as compared to a claim that arose in Wyoming).

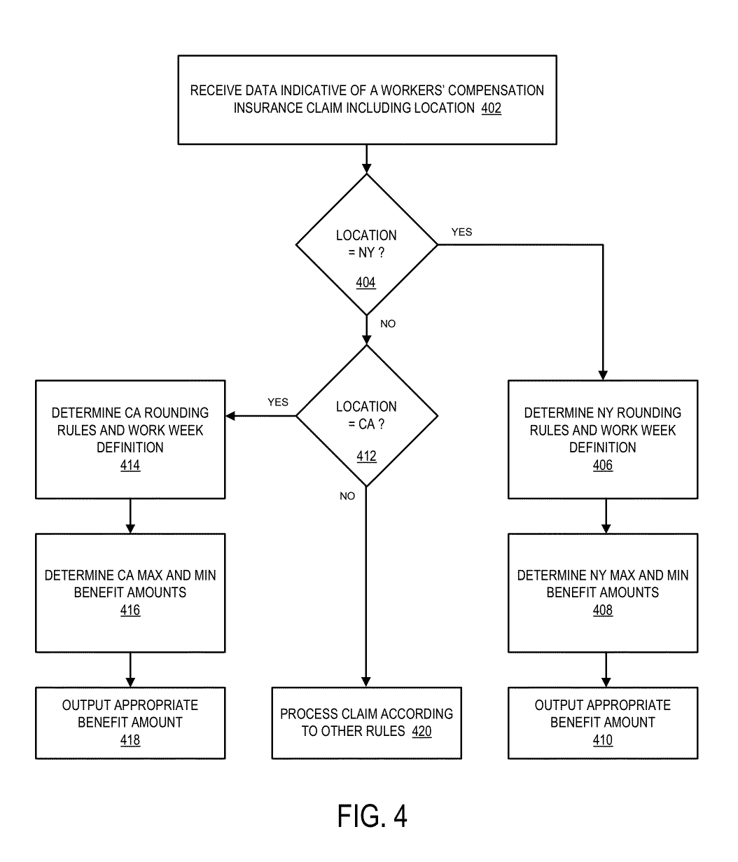

FIG. 4 illustrates a method that might be performed by some or all of the elements of the system 300 described with respect to FIG. 3 according to some embodiments of the present invention. At 402, data may be received indicative of a plurality of insurance claims submitted in connection with workers' compensation insurance policies. Each insurance claim might be associated with a location, such as a state or jurisdiction where the claim arose. Note that the data indicative of insurance claims might be received via submitted paper claims, a telephone call center, an online claim submission web page, etc. in connection with a First Notice Of Loss (“FNOL”). Although some embodiments are described with respect to a newly received insurance claim, note that any of the embodiments described herein may be performed in connection with an insurance claim currently being processed by a claim handler. For example, if information about the insurance claim changes (e.g., more information about an injury associated with the claim becomes available), the system may dynamically and automatically adjust the benefit amounts associated with the claim.

At 404, it may be automatically determined if the insurance claim is located in “NY.” If so, embodiments may determine New York rounding rules (e.g., indicating that benefit amounts are to be rounded up to the nearest dollar value) and work week definition (e.g., New York might define a work week as five business days) at 406. The system may also at 408 automatically determine appropriate maximum and minimum benefit amounts required in New York (if applicable). As a result of these rules and regulations, appropriate benefit amounts for the insurance claim may be output at 410.

If it was determined that the insurance claim was not located in “NY” at 404, it may be automatically determining if an insurance claim is located in “CA.” If so, embodiments may determine California rounding rules (e.g., indicating that benefit amounts are to be rounded up to the nearest penny) and work week definition (e.g., California might define a work week as seven days) at 414. The system may also at 416 automatically determine appropriate maximum and minimum benefit amounts required in California (if applicable). As a result of these rules and regulations, appropriate benefit amounts for the workers' compensation claim may be output at 418.

If the insurance claim is not located in “CA” at 412, appropriate benefit amounts may be determined with other logic at 420, such as rules and regulations associated with other states or countries. Note that these rules and regulations might be associated with, for example, a benefit frequency, a minimum benefit amount, a maximum benefit amount, a work week definition, an overall benefit cap, and/or a benefit waiting period. Moreover the workers' compensation benefits might be associated with Temporary Total Disablement (“TTD”), Temporary Partial Disablement (“TPD”), Permanent Total Disablement (“PTD”), Permanent Partial Disablement (“PPD”), and/or death benefits. Still further, embodiments may facilitate the provision of Temporary Income Benefits (“TIBs”), Partial Temporary Income Benefits (“Partial TIBs”), Impairment Income Benefits (“IIBs”), Supplemental Income Benefits (“SIBs”), Lifetime Income Benefits (“LIBs”), and/or Disability Insurance Benefits (“DIBs”). As still other examples, embodiments may be associated with a permanent total supplemental benefit, an impairment income benefit, a lifetime income benefit, and/or a death income benefit

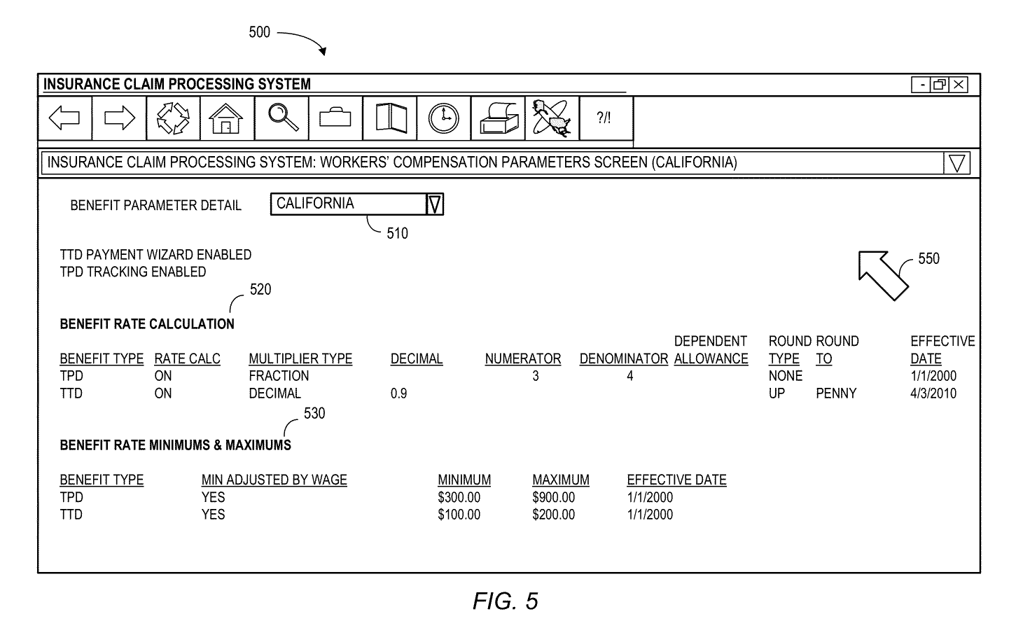

FIG. 5 illustrates a workers' compensation parameters display 500 in accordance with some embodiments. The display 500 includes a user selectable state entry portion 510. According to some embodiments, the state entry portion 510 is automatically populated based on claim data. Moreover, a claim handler might use a touch screen or computer mouse pointer 550 to define a United States state associated with the workers' compensation insurance claim. The display 500 may be associated with, for example, rules, logic, parameters, etc., on a state-by-state basis, that may be used to automatically calculate benefit amounts for workers' compensation claims. The display 500 may also include indications of whether a TTD payment wizard and/or a TPD tracking function are currently enabled (and, in some embodiments, the user may toggle the enablement).

A benefit rate calculation portion 520 may include, for the selected state, a benefit type (e.g., TPD or TTD), a rate calculator enablement status (on or off), a multiplier type (e.g., fraction or decimal to be used to reduce payment in view of attorney costs, child support obligations, etc.), a decimal value (when the multiplier type is decimal), a numerator and denominator (when the multiplier type is fraction), a combination of decimal and fraction multipliers, a variable multiplier (e.g., associated with a formula that may be modified based on a claimant's hourly rate or a dependent allowance field), a rounding type (e.g., up, down, nearest, or none), a round to field (e.g., to nearest dollar, quarter, nickel, or penny), and an effective date. A benefit rate minimums and maximums portion 530 may include a benefit type, a minimum adjusted by wage indication (yes or no), a minimum value, a maximum value, and an effective date. Note that the effective dates may, according to some embodiments, enable the system to correctly calculate values over a time period that spans different rules (e.g., when a cost of living increase is applied at the end of a year).

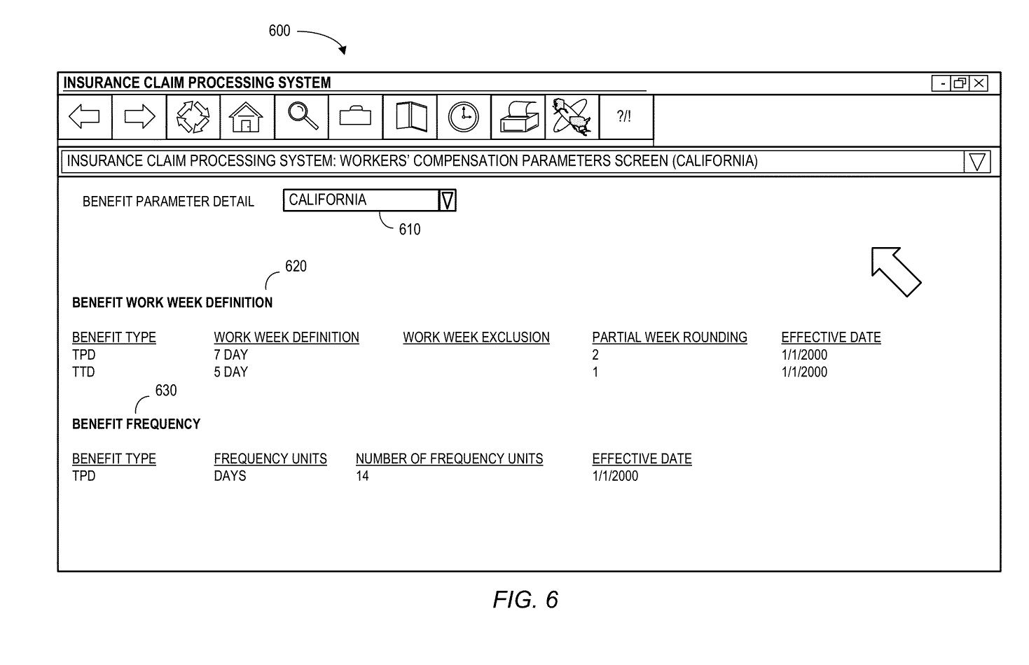

FIG. 6 illustrates another workers' compensation parameters display 600 containing other parameters in accordance with some embodiments. As before, the display 600 includes a user selectable state entry portion 610, and also includes a benefit work week definition portion 620 having the benefit type, a workweek definition (e.g., five or seven days), a work week exclusion field, a partial week rounding field, and an effective date. The display 600 further includes a benefit frequency portion 630 including the benefit type, frequency units (e.g., days or weeks), a number of frequency units, and an effective date.

Thus, some embodiments described herein provide customized parameters for benefit minimums and maximums, work week definition, layer benefit caps, or waiting period parameters and each of these may be used to automate WC reconciliation as appropriate. For example, the work week definition may allow the system to calculate an appropriate amount that should be paid for a period of time. While most states are 7 day work week states, the display may distinguish between the following work week definitions: 7 day, 6 day, 5 day, and/or variable (using either the claimant work schedule or the business days of the employer depending on the state). According to some embodiments, an algorithm may use the work week definition parameter, among other things, to calculate an amount owed in a TTD payment wizard for multiple states and other benefit types in a reconciliation screen.

For example, for an open period, every day may have the same amount. This is, if a user happens to go to a reconciliation tool mid-week, he or she probably does not need to pay a “partial week” if the period is still open. Once the period closes, the system may automatically calculate the correct amount for the partial week, and then adjust the last day, so that the total amount is correct. For example, if the regular daily rate is $100, and its 4 days, and state requires the insurer to pay $399.02 dollars for 4 days, than the daily amounts will show $100, $100, $100, and $99.02.

According to some embodiments, the system may calculate the amount owed for the partial week as follows:

A state parameter may be added called multiplier_rounding_partial_week (each claim may be associated with a days_per_week, such as 5, 6, 7, or based on employer, etc.).

If multiplier_rounding_partial_week for a particular state is “No Multiplier” then exit, because there is no need to do a partial week calculation.

Calculate days_in_last_week (in prior example that would be 4).

If days_in_last_week is greater or equal to days_per_week then exit (i.e., nothing needs to be adjusted, and the system wouldn't treat it as partial week).

For example, in a 5 day state, if benefits days equals 5, 6 or 7 then nothing needs to be adjusted (the system only needs to perform an adjustment if it is 4 or less).

Set multiplier to (1/days_per_week*days_in_last_week) rounded to multiplier_rounding_partial_week places after the decimal for that particular state. In the prior example, it would be (1/7*4) round 2=0.57.

Set Amount_owed_partial_week to (Benefit_rate*multiplier) rounded to nearest penny. In the prior example (700.03*0.57) round 2=399.02

As a result, the last 4 days of the period would be $100, $100, $100, $99.02 (i.e., last day was adjusted from $100 to $99.02).

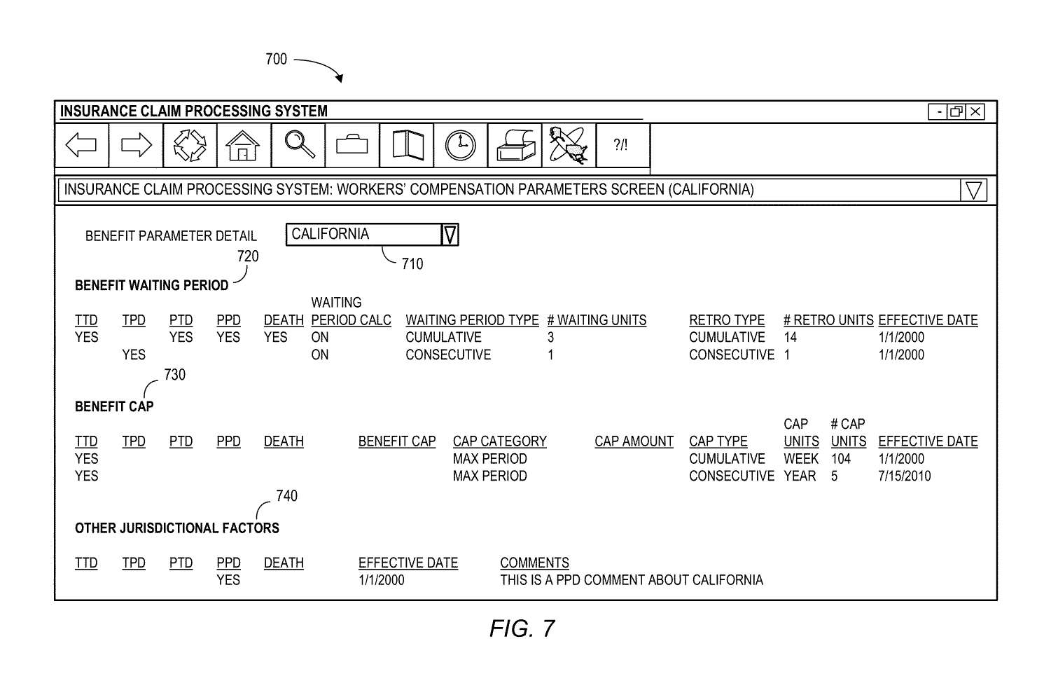

FIG. 7 illustrates yet another workers' compensation parameters display 700 containing still more parameters in accordance with some embodiments. As before, the display 700 includes a user selectable state entry portion 710, and also includes a benefit waiting period portion 720 indicating, for each of the various types of benefits (TTD, TPD, PTD, PPD, and death benefits), an indication of whether a waiting period calculator is enabled (yes or no), a waiting period type (e.g., calendar, cumulative or consecutive days), a number of waiting units, a retroactive type (e.g., calendar, cumulative or consecutive days), a number of retroactive units, and an effective date. The display 700 further includes a benefit cap potion 730, indicating, for each of the various types of benefits (TTD, TPD, PTD, PPD, and death benefits), a benefit cap field, a cap category, a cap amount, a cap type, cap units, and number of cap units, and an effective date. According to some embodiments, the system may allow for “layered” benefit caps. For example, the system may have the ability to layer a number of different types of benefits caps (e.g., total amount of benefits, length of benefit duration—cumulative, length of benefit duration—consecutive) as well as the ability to apply the same cap to one or more benefits types. Benefit cap parameters may be used for payment validation and may accommodate numerous state configuration combinations. Moreover, the display 700 may include another jurisdictional factors portion 740 indicating, for each of the various types of benefits (TTD, TPD, PTD, PPD, and death benefits), an effective date and a comment to be provided to users.

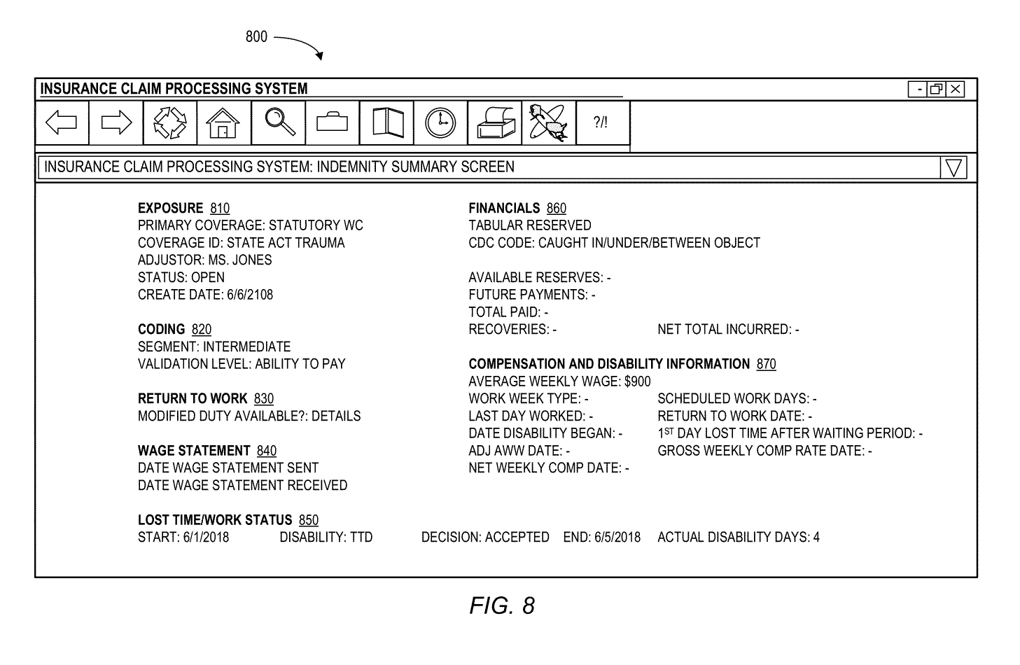

FIG. 8 is an indemnity summary display 800 that may be provided according to some embodiments. The indemnity summary display 800 includes an exposure portion 810 containing a primary coverage, a coverage identifier, an adjustor, a status, and a create date. A coding portion 820 may include a segment (e.g., intermediate or difficult) and a validation level (e.g., ability to pay). A return to work portion 830 may indicate whether or not modified duty was available. A wage segment portion 840 may display dates on which a wage statement sent and/or was received. The display 800 may further include a financials portion 860, a tabular reserved filed, a CDC code and/or description, an amount of available reserves, future payments, a total paid amount, recoveries, and a net total incurred value. A compensation and disability information portion 870 may include an average weekly wage amount, a work week type, scheduled work days, a last day worked, a return to work date, a date disability began, a 1st day lost time after waiting period, an adjusted average weekly wage date, a gross weekly compensation rate date, and net weekly compensation date. The display 800 may further include a lost time/work status portion 850 with a start, date, a disability type, a decision, an end date, and actual disability days.

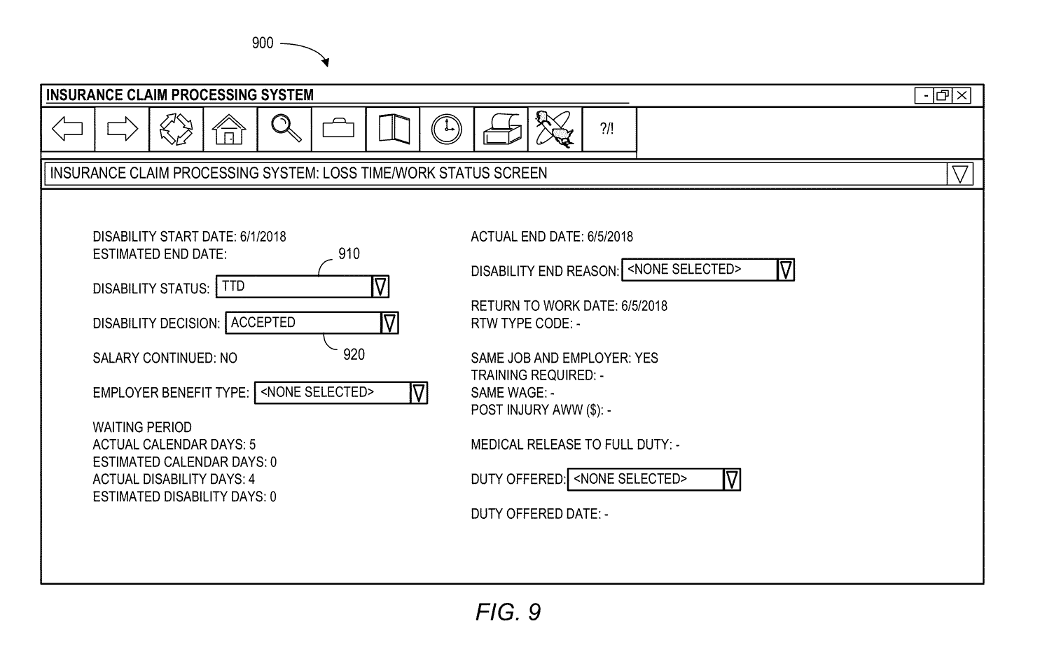

FIG. 9 illustrates a loss time/work status display 900 in accordance with some embodiments. For a period of time between a disability start date and a disability end date, the display 900 may let a user select a disability status 910 (TTD, TPD, etc.) and a disability decision 920 for the insurance claim. Other information in the display 900 may include, for example, whether the employee's salary was continued, an employee benefit type, waiting period information, a return to work date, post-return to work data (whether training was required, whether the employee received the same wage upon return, etc.), and information about the duties of the employee associated with the workers' compensation insurance claim.

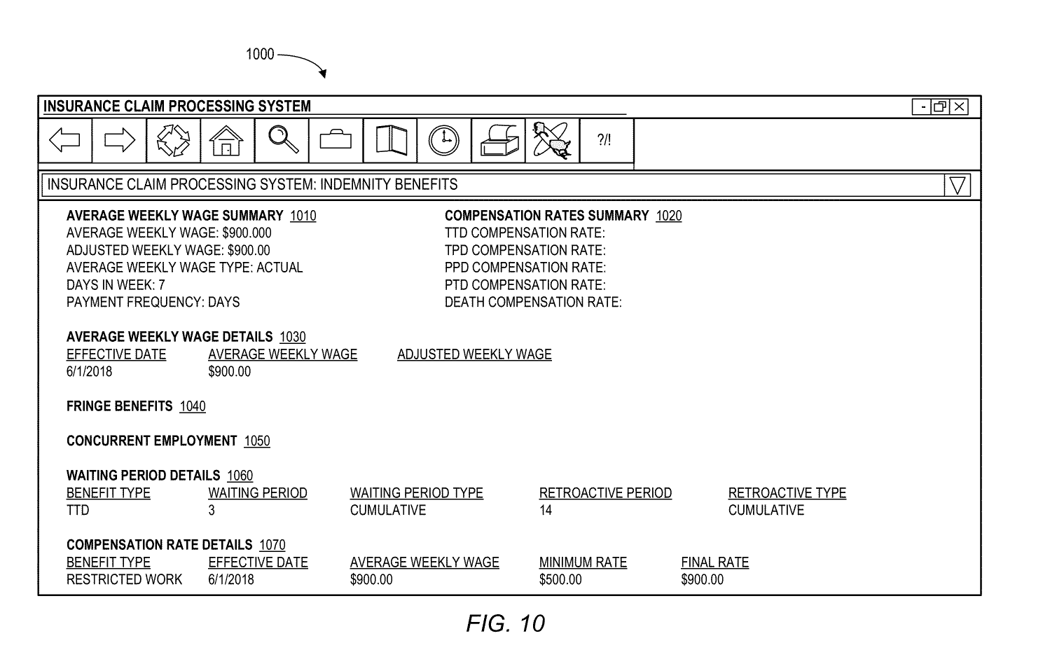

FIG. 10 is an indemnity benefits display 1000 that may be provided according to some embodiments. The indemnity benefits display 1000 may include an average weekly wage summary portion 1010 providing an average weekly wage value, an adjusted average weekly wage value, average weekly wage type, a definition of a work week, and an indication of payment frequency. A compensation summary portion 1020 may provide compensation rates for TTD, TPD, PPD, and death compensation. The indemnity benefits display 1000 may further include an average weekly wage details portion 1030 that provides an effective date for an average and/or adjusted weekly wage. According to some embodiments, the indemnity benefits display 1000 further includes a fringe benefits portion 1040 and/or a concurrent employment portion 1050. A waiting period details portion 1060 may provide, for a benefit type, a waiting period value and type (e.g., cumulative or continuous) along with a retroactive period value and type. The indemnity benefits display 1000 may further include a compensation rate details portion 1070 providing, for a benefit type, an effective date, average weekly wage, minimum rate, and a final rate for the workers' compensation claim.

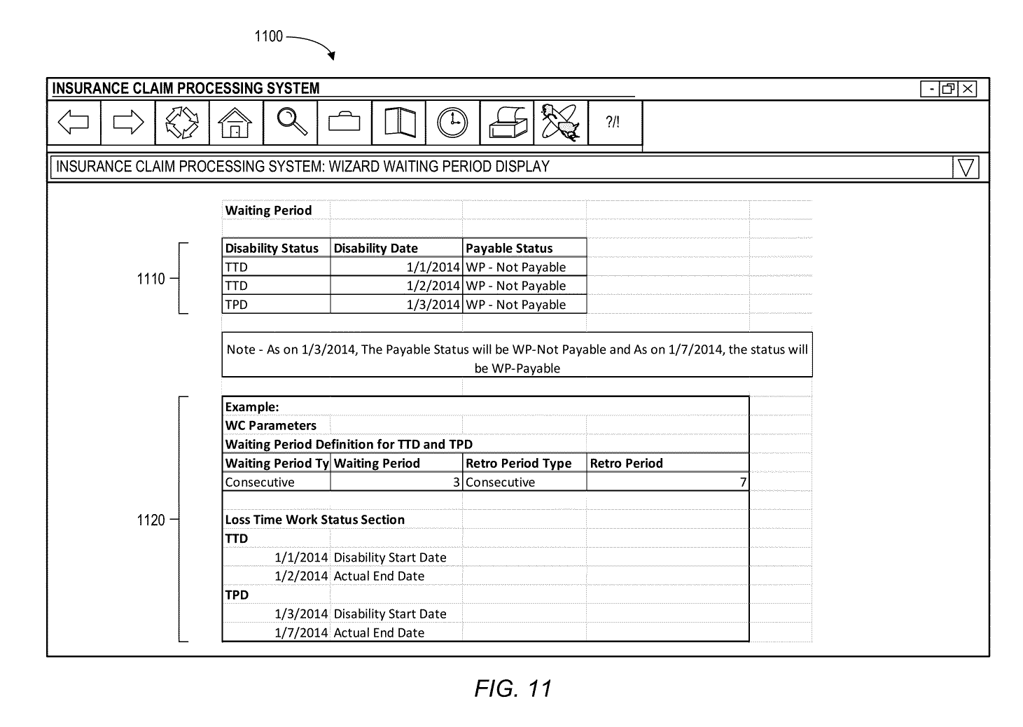

FIG. 11 illustrates a wizard waiting period 1100 display in accordance with some embodiments. A disability status portion 1110 may indicate a disability type, disability date, and payable status based on the location of the workers' compensation claim. An example portion 1120 may provide a lost time/work status section such that if a “Disability Decision” is denied for a benefit type, then that benefit type will not be populated. According to some embodiments, the disability status in the disability status portion 1110 will be populated from the lost time/work status section based on the record added for the benefit type. Note that waiting period dates (days) might be displayed, for example, based on the disability period given in the loss time/work status display 900 for FIG. 9. The payable status in the disability status portion 1110 may be a user editable dropdown selection (e.g., with values “Waiting Period—Not Payable,” “Waiting Period—Payable,” and “Payable”).

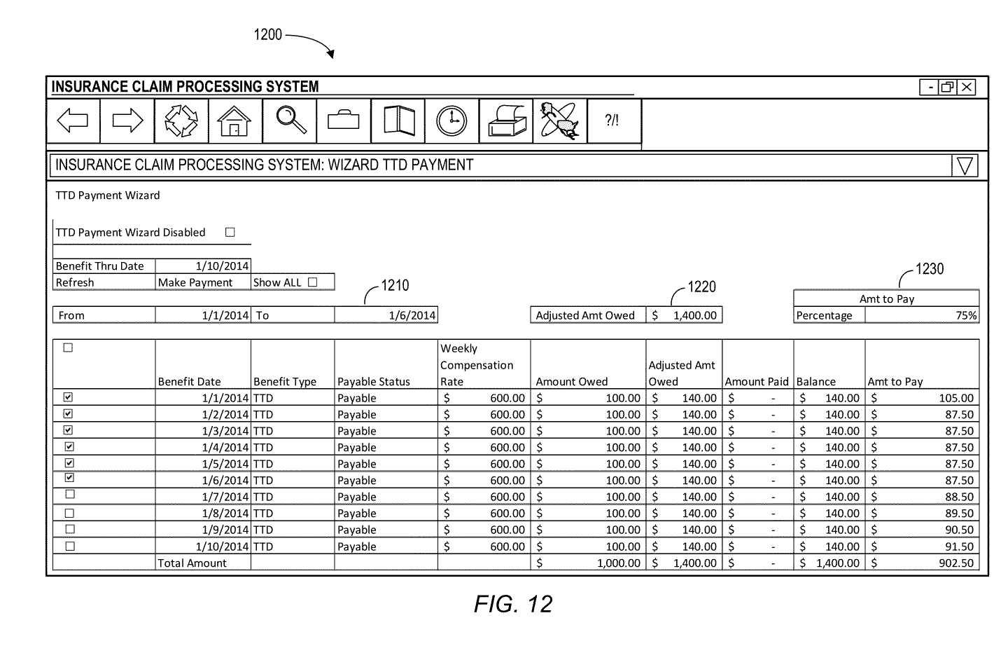

FIG. 12 is a wizard payment display 1200 that may be provided according to some embodiments. The display 1200 may let a user disable a TTD payment wizard for the life of a claim. Note that features of TTD payments may be made through a payment wizard in a financial application. A benefit through date may be a user editable item defining which transaction items need to be populated. The display 1200 may let a user select “Refresh” such that the latest transaction for the disability period will be generated based on: disability status, disability start date and actual end date in the lost time/work status section of the indemnity summary display 800 of FIG. 8; the final rate in the compensation rate details portion 1070 of the indemnity benefits display 1000 of FIG. 10; and the benefit waiting period section 720 of the workers compensation parameters display 700 of FIG. 7. Upon selection of a “make payment” button, payment details for checked transactions will be pre-populated in a payment wizard. The system may, according to some embodiments, automatically take the user to an initial step of the payment wizard to create a check for the claimant. According to some embodiments, the user may be able to create a “one-time” check or a check will be automatically generated on a periodic basis (e.g., every two weeks). In this way, the display 1200 may facilitate a user arranging to provide and track payments of appropriate benefit amounts to workers.

The display 1200 provides a defined time period 1210, and adjusted amount owed 1220, and an amount to pay 1230. If a user selects a “dollar” amount to pay 1230, the system may populate a currency field, and if the user selects “percentage” the system may populate an x % (numeric) field. In that case, the x % will be applied on the balance due and the amount to pay 1230 is populated with the resulting value. If the user selects “dollar” from the dropdown and gives a value x$, then the x$ may be multiplied with the balance divided by the total balance and the amount to pay 1230 may be distributed accordingly with the result. If the user changes individual amounts to pay in the transaction grid, then the overall amount to pay 1230 may be updated accordingly. The display further includes, for a plurality of benefit dates, a benefit type, a payable status (e.g., waiting period, payable, etc.), a weekly compensation rate, an amount owed, an adjusted amount owed, an amount already paid, a balance (e.g., a reconciliation amount represented the difference between the amount owed and the amount already paid), and an amount to be paid. Total amounts for these values may also be provided. A user may select a check box next to one or more of the benefit dates to arrange for payment to be initiated (e.g., in accordance with the “amount to be paid”).

Note that the display 1200 may facilitate a comparison of what is owed with what has been paid and calculate any overpayment/underpayments if applicable. According to some embodiments, the same logic used to calculate the amount owed for all benefit types may also be used to determine the amount owed on a reconciliation screen. This may be facilitated by employing day-by-day calculations (including a generation of amounts owed/paid/balance at a daily level). Calculating what is owed at the daily level may enable automation of adjustments if needed in the future for any period of time. It may also provide the ability to see if a claim is reconciled in real-time (e.g., “as of today”).

Further note that embodiments may provide the ability to pay a portion of the amount owed now and a portion at a later date (as well as the ability to pay those portions to one or more payees). For example, some embodiments may provide an ability to pay a percentage of the amount owed for the days selected. The benefit of such an approach may compound when a user goes back to pay the remainder. When this happens, the system may already have calculated how much is owed for each day, along with exactly how much was just paid for the each day, and automatically determine the difference for the user. The user may re-enter the tool, for example, and select the same days as before and in one click pay the remaining percent owned to the same payee (or a different payee if warranted).

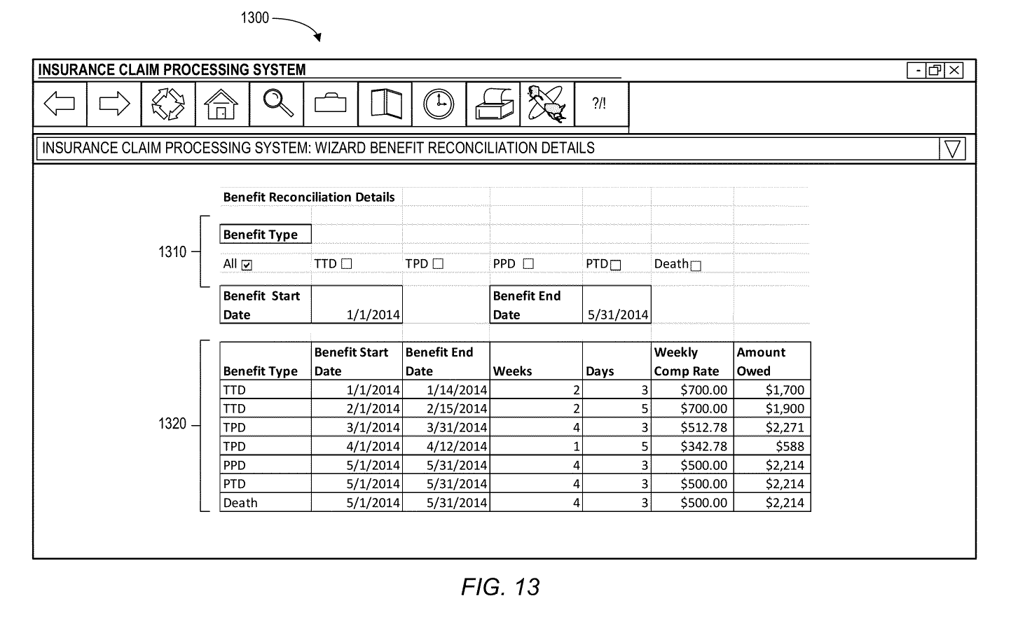

FIG. 13 illustrates a wizard benefit reconciliation details display 1300 in accordance with some embodiments. In a benefit type portion 1310, a selectable checkbox may be provided for “all,” TTD, TPD, PPD, PTD, and death benefits. According to some embodiments, the display might be altered for Texas insurance claims to instead display TIBs, Partial TIBs, IIBs, SIBs, LIBs, and DIBs. Selection of the checkboxes in the benefit type portion 1310 will act as filter for the display of benefits in a benefit portion 1320. For each benefit in the benefit portion 1320 (e.g., during a period from a benefit start date to a benefit end date entered by a user), the following data may be automatically calculated and displayed: a benefit type, a benefit start date, a benefit end date, a number of weeks, a number of days, a weekly compensation rate, and an amount owed in connection with the workers' compensation insurance claim.

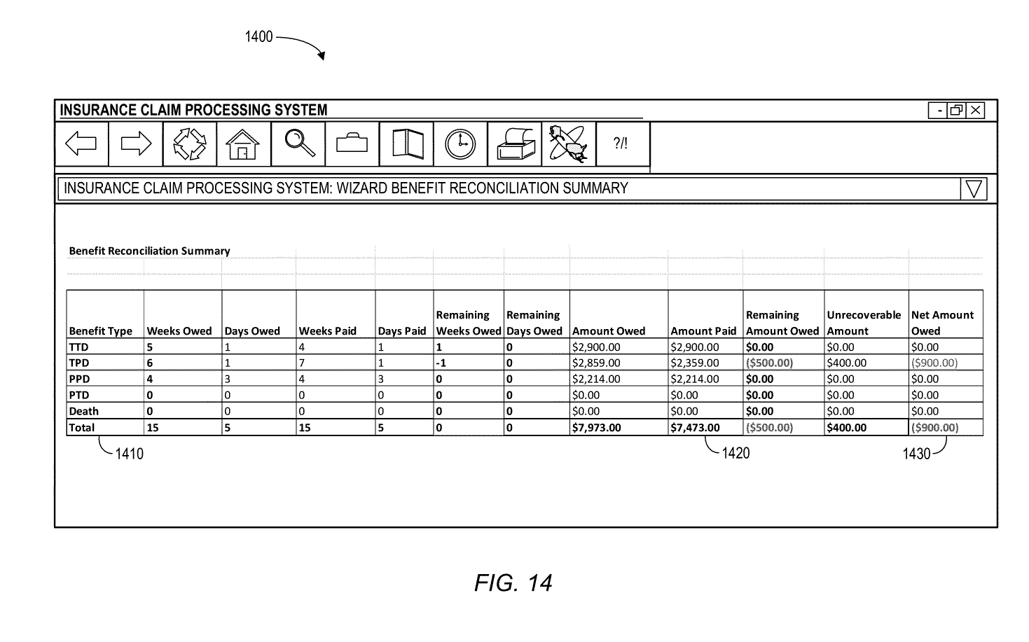

FIG. 14 is a wizard benefit reconciliation summary display 1400 that may be provided according to some embodiments. For each benefit type, the wizard benefit reconciliation summary display 1400 may provide weeks owed, days owed, weeks paid, days paid, remaining weeks owed, remaining days owed, amount owed, amount paid, remaining amount owed, unrecoverable amount, and a net amount owed. Moreover, the wizard benefit reconciliation summary display 1400 may include totals 1410, such as an overall total amount paid 1420 and net amount owed 1430 (which might, according to some embodiments, be either a positive or negative value). The unrecoverable amount field on the display 1400 may let a user reconcile in states that do not allow an insurer to recover overpayments of a particular benefit type.

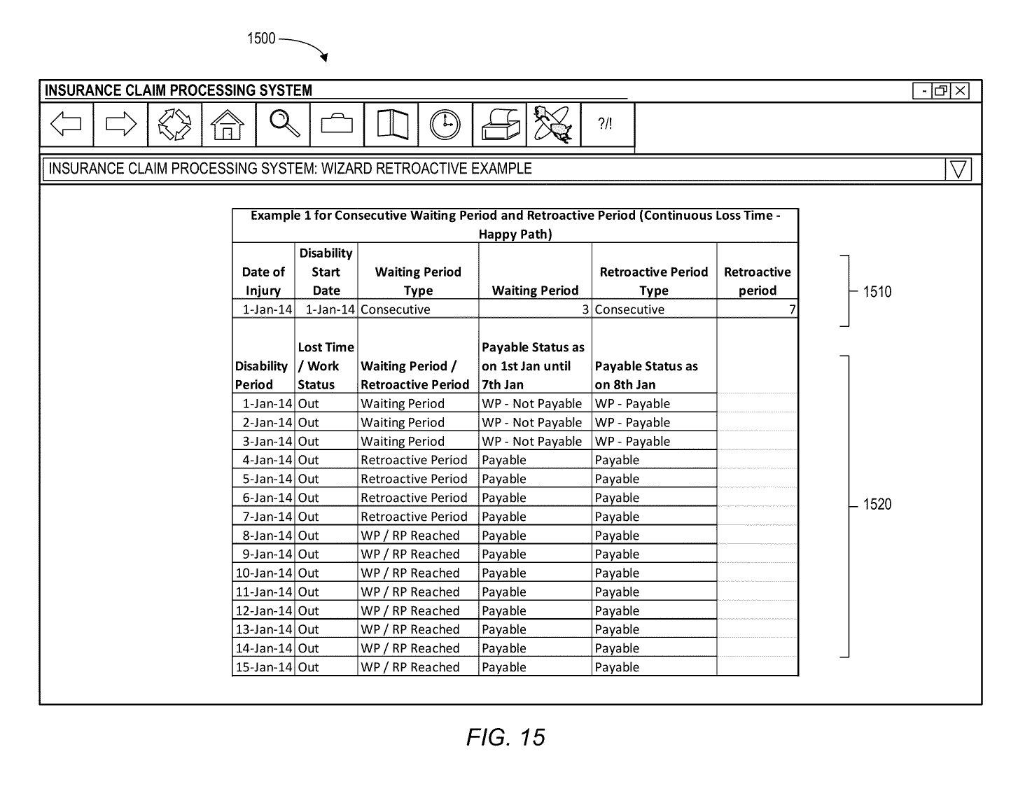

Depending on the location of a workers' compensation insurance claim, only those employees who are physically unable to perform their usual job task for more than pre-determined period of time (e.g., seven days) following the date of an injury are eligible to receive periodic compensation payments. This period of time (which may be consecutive or cumulative depending on the location) is referred to as a “waiting period” during which no periodic compensation payment are due. However, if an employee is off work for more than a certain number of days (business or calendar days that are referred to as “the retroactive period”), then the periodic compensation for waiting period might be paid retroactively to the employee (again, depending on the location). FIGS. 15 through 24 will illustrate displays of waiting period and retroactive period examples in accordance with some embodiments.

Referring to FIG. 15, an example display 1500 is provided for an injury occurring on Jan. 1, 2014 in a location where there is a consecutive 3 day waiting period and a consecutive 7 day retroactive period 1510. As shown by the disability period 1520 associated with the insurance claim, the first 3 days have a status of “WP—Not Payable” until the January 8 (during the 7 day retroactive period). Starting January 8, all 3 waiting period days switch to “WP—Payable.”

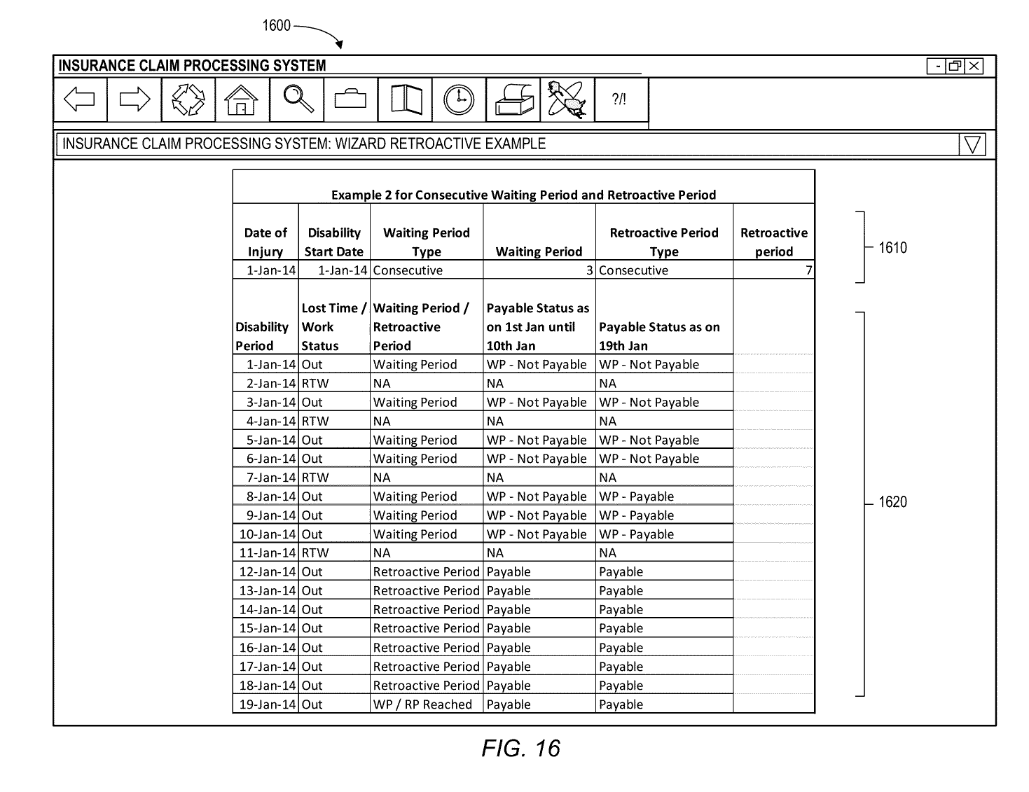

Referring to FIG. 16, an example display 1600 is provided for an injury occurring on Jan. 1, 2014 in a location where there is a consecutive 3 day waiting period and a consecutive 7 day retroactive period 1610. As shown by the disability period 1620 associated with the insurance claim, the employee missed some days of work but did not miss 3 consecutive days until January 10. Moreover, he or she did not satisfy the 7 consecutive day retroactive period requirement until January 19. Thus, on January 19 the waiting period eligible work absences become payable (that is, those absences starting on January 8 representing the start of the qualifying 3 consecutive day waiting period). The absences prior to the start of the qualifying 3 consecutive day waiting period (January 1, 3, 5, and 6) never become payable. Note that a payment status of Not Applicable (“NA”) populates the days on which the employee Returned To Work (“RTW”) because he or she was already paid for working those days.

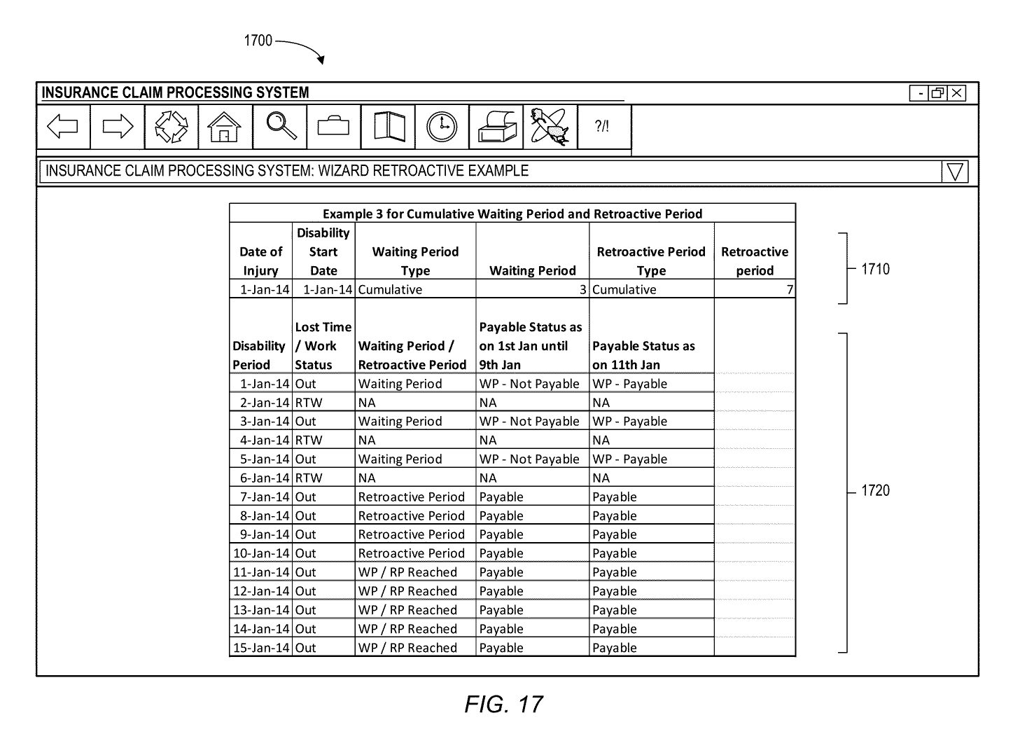

Referring to FIG. 17, an example display 1700 is provided for an injury occurring on Jan. 1, 2014 in a location where there is a cumulative 3 day waiting period and a cumulative 7 day retroactive period 1710. As shown by the disability period 1720 associated with the insurance claim, the employee missed some days of work but did not miss 3 consecutive days until January 10. However, because the waiting period is defined as “cumulative” in this state/location, the non-consecutive days of January 1, 3, and 5 satisfy the waiting period requirement. As a result, the cumulative retroactive period is satisfied on January 11 and all of the absences become “WP—Payable.”

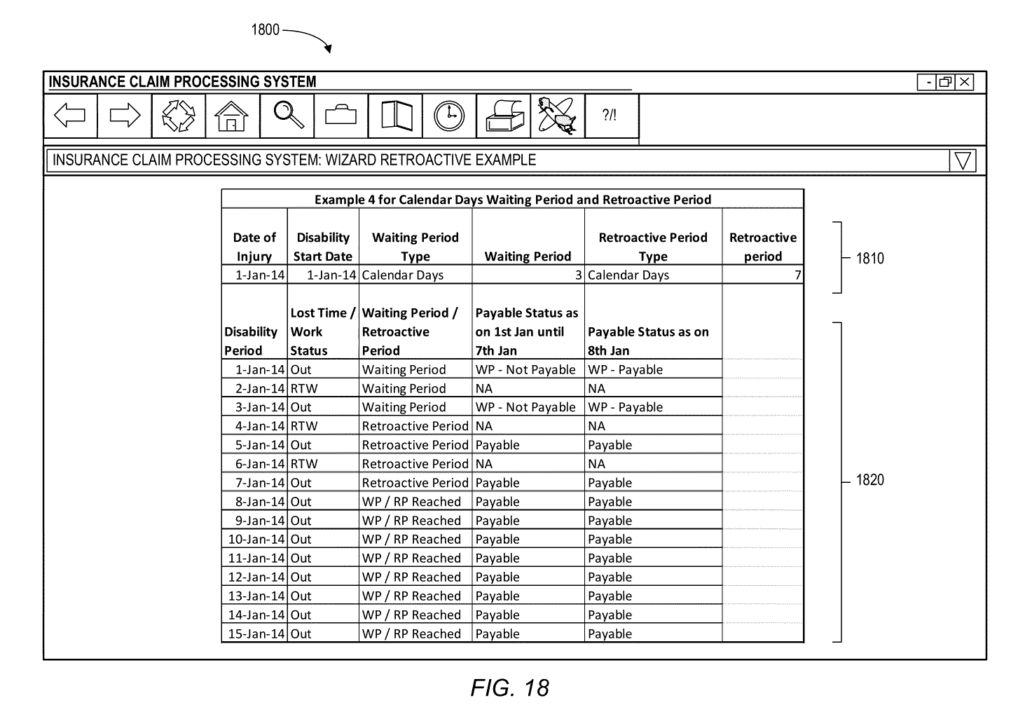

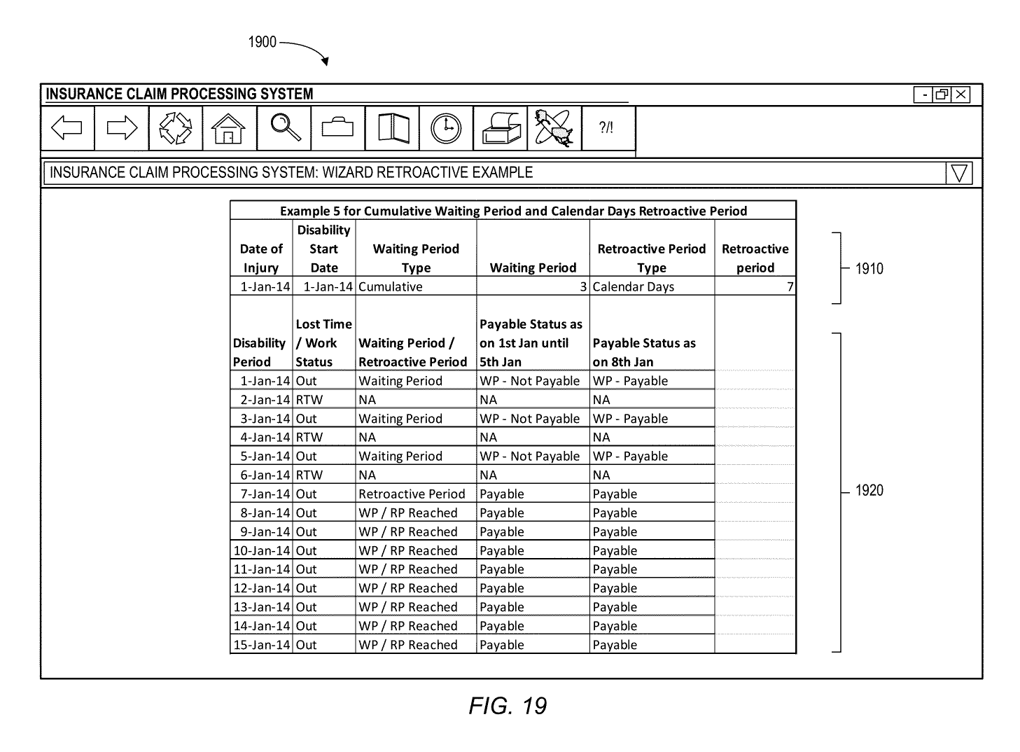

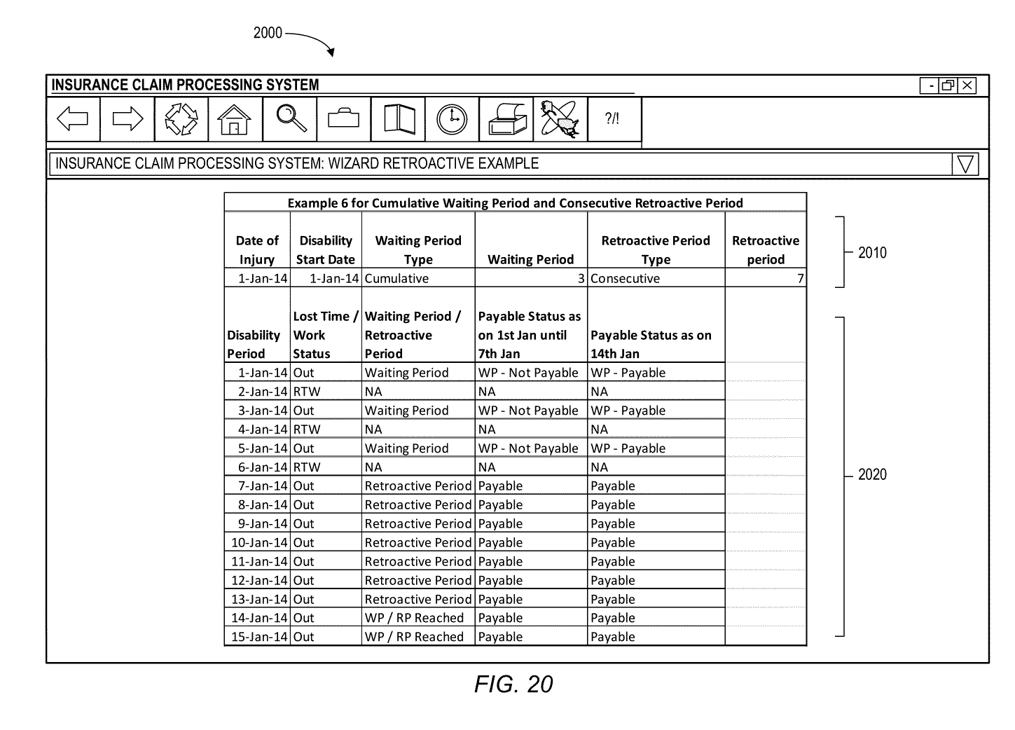

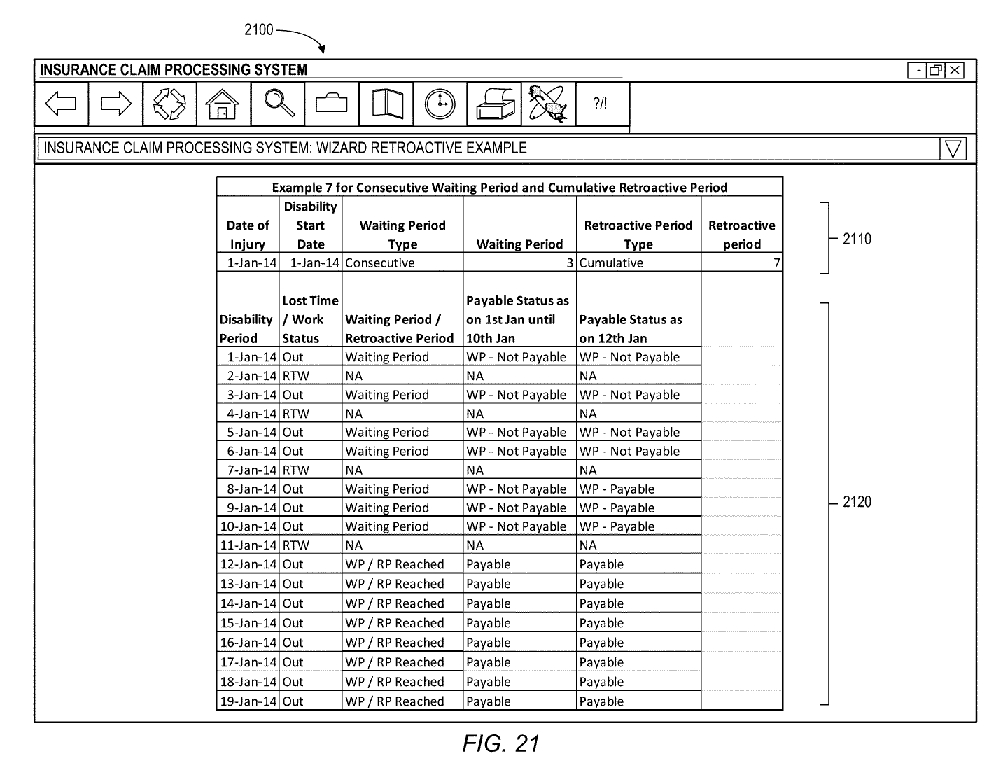

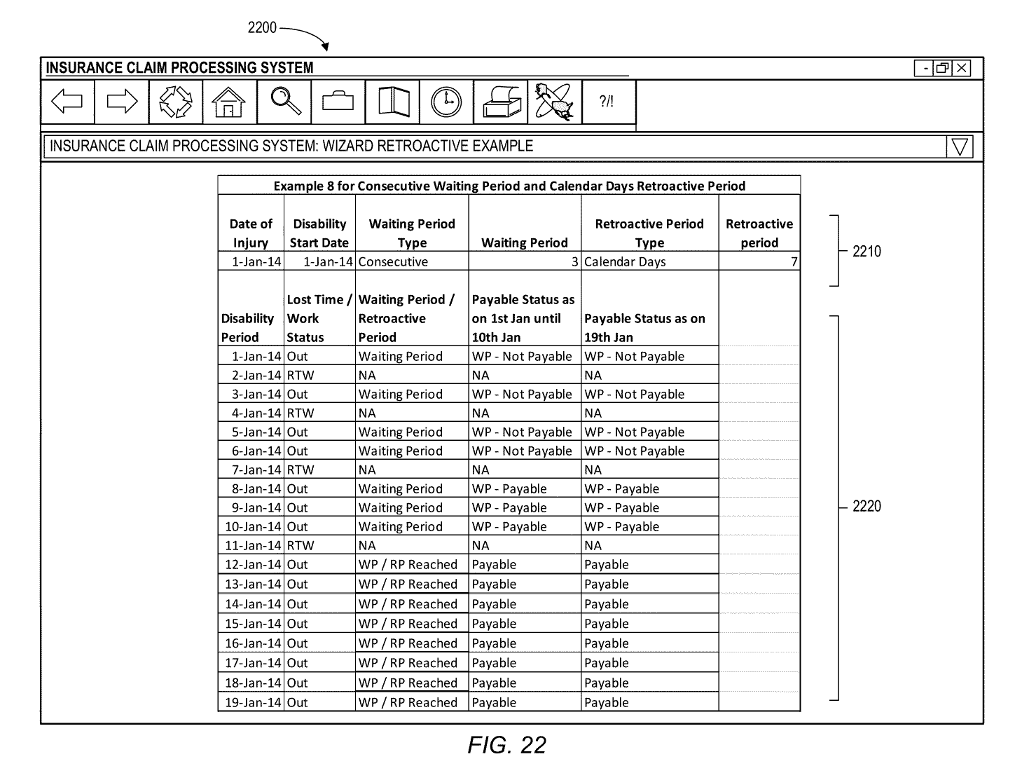

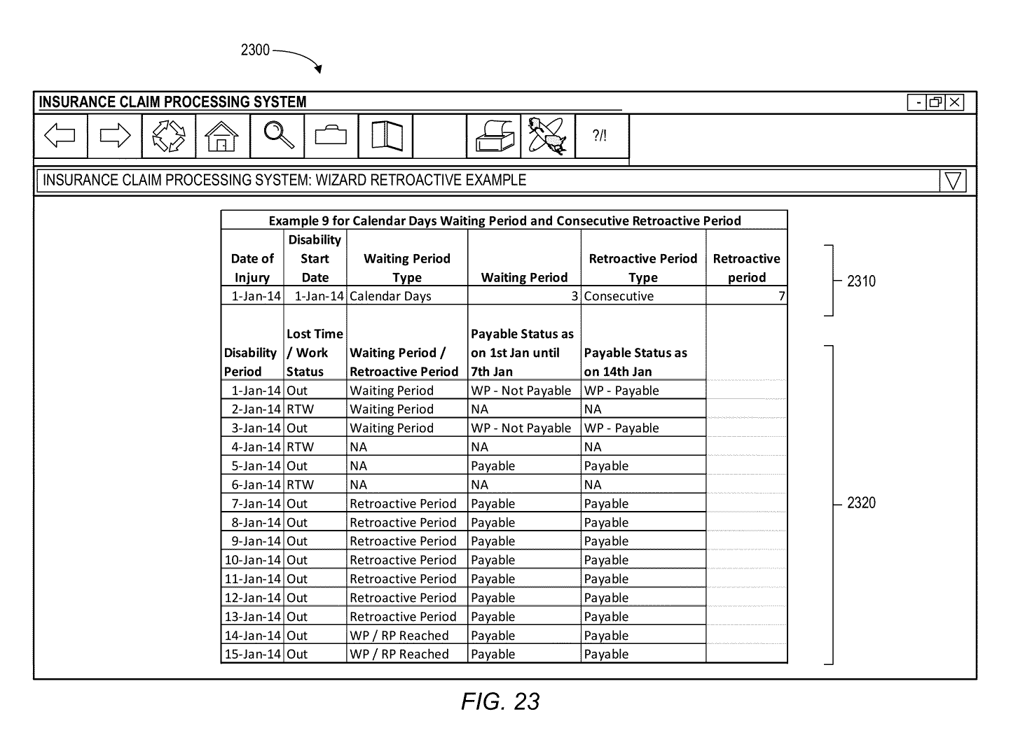

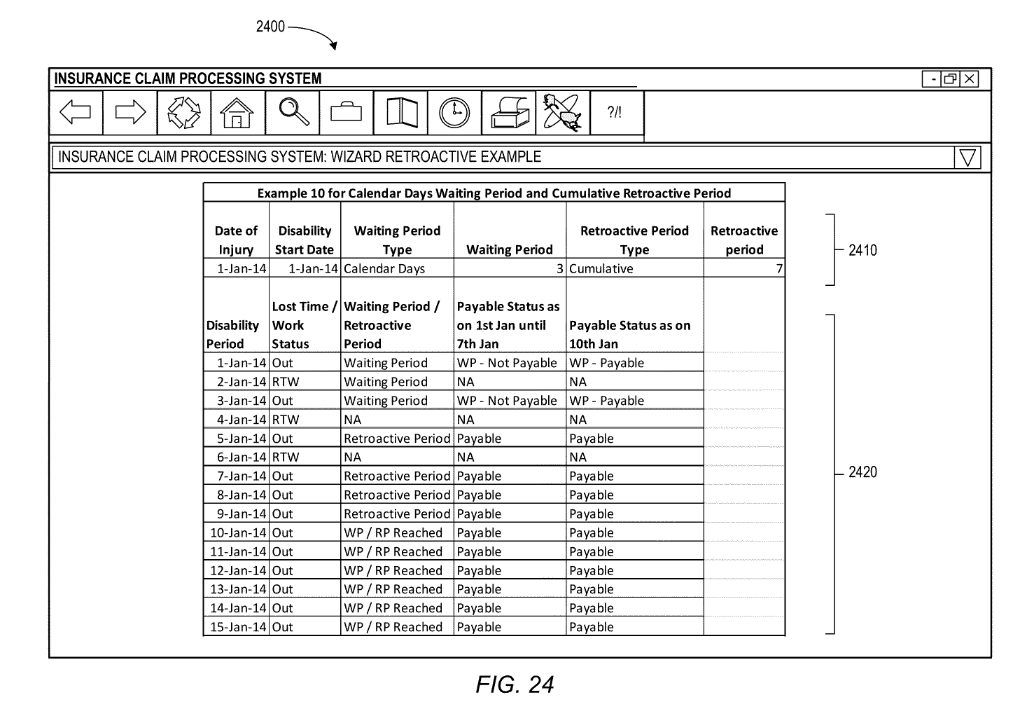

Referring to FIG. 18, an example display 1800 is provided for an injury occurring on Jan. 1, 2014 in a location where there is a “calendar” 3 day waiting period and a calendar 7 day retroactive period 1810. As used herein, a “calendar” day waiting period (as opposed to consecutive or cumulative day waiting periods) means that each day after an initial qualify event counts toward satisfying the period requirement—regardless of whether or not the employee missed work each day. Referring to FIG. 19, an example display 1900 is provided for an injury occurring on Jan. 1, 2014 in a location where there is a cumulative 3 day waiting period and a calendar 7 day retroactive period 1910. Referring to FIG. 20, an example display 2000 is provided for an injury occurring on Jan. 1, 2014 in a location where there is a cumulative 3 day waiting period and a consecutive 7 day retroactive period 2010. Referring to FIG. 21, an example display 2100 is provided for an injury occurring on Jan. 1, 2014 in a location where there is a consecutive 3 day waiting period and a cumulative 7 day retroactive period 2110. Referring to FIG. 22, an example display 2200 is provided for an injury occurring on Jan. 1, 2014 in a location where there is a consecutive 3 day waiting period and a calendar 7 day retroactive period 2210. Referring to FIG. 23, an example display 2300 is provided for an injury occurring on Jan. 1, 2014 in a location where there is a calendar 3 day waiting period and a consecutive 7 day retroactive period 2310. Referring to FIG. 24, an example display 2400 is provided for an injury occurring on Jan. 1, 2014 in a location where there is a calendar 3 day waiting period and a cumulative 7 day retroactive period 2410.

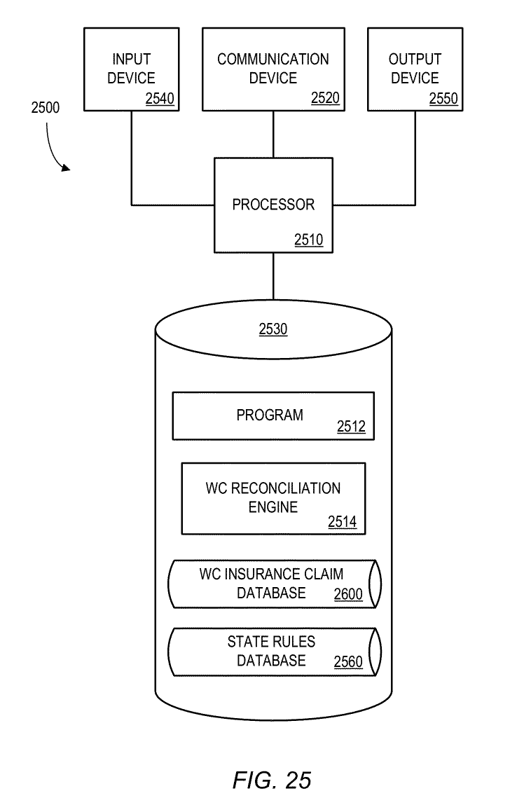

Note that the embodiments described herein may be implemented using any number of different hardware configurations. For example, FIG. 25 illustrates a workers' compensation reconciliation platform 2500 that may be, for example, associated with the systems 100, 300 of FIGS. 1 and 3. The workers' compensation reconciliation platform 2500 comprises a processor 2510, such as one or more commercially available Central Processing Units (CPUs) in the form of one-chip microprocessors, coupled to a communication device 2520 configured to communicate via a communication network (not shown in FIG. 25). The communication device 2520 may be used to communicate, for example, with one or more claim systems, remote team leaders, payment applications, and/or claim handler devices. The workers' compensation reconciliation platform 2500 further includes an input device 2540 (e.g., a mouse and/or keyboard to enter information about location based reconciliation rules) and an output device 2550 (e.g., to output an indication of an appropriate benefit amount, a report, or a spreadsheet).

The processor 2510 also communicates with a storage device 2530. The storage device 2530 may comprise any appropriate information storage device, including combinations of magnetic storage devices (e.g., a hard disk drive), optical storage devices, mobile telephones, and/or semiconductor memory devices. The storage device 2530 stores a program 2512 and/or a WC reconciliation engine 2514 for controlling the processor 2510. The processor 2510 performs instructions of the programs 2512, 2514, and thereby operates in accordance with any of the embodiments described herein. For example, the processor 2510 may receive data indicative of a plurality of insurance claims submitted in connection with insurance policies along with a location for each insurance claim. The processor 2510 may then automatically determine a first workers' compensation benefit rule for a first workers' compensation insurance claim associated with a first location. Similarly, a second workers' compensation benefit rule (different from the first workers' compensation benefit rule) may be determined by the processor 2510 for a second workers' compensation insurance claim associated with a second location. A first benefit amount and a second benefit amount may then be automatically calculated by the processor 2510 for the workers' compensation insurance claims based on the rules, and indications of the first and second benefit amounts may be transmitted from the processor 2510.

The programs 2512, 2514 may be stored in a compressed, uncompiled and/or encrypted format. The programs 2512, 2514 may furthermore include other program elements, such as an operating system, a database management system, and/or device drivers used by the processor 2510 to interface with peripheral devices.

As used herein, information may be “received” by or “transmitted” to, for example: (i) the workers' compensation reconciliation platform 2500 from another device; or (ii) a software application or module within the workers' compensation reconciliation platform 2500 from another software application, module, or any other source.

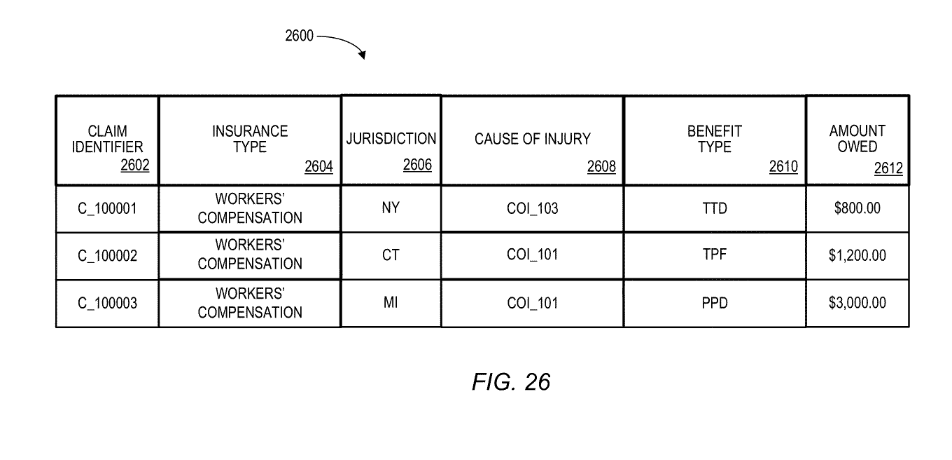

In some embodiments (such as shown in FIG. 25), the storage device 2530 further stores a WC insurance claim database 2600 and a state rules database 2560. An example of a database that may be used in connection with the workers' compensation reconciliation platform 2500 will now be described in detail with respect to FIG. 26. Note that the database described herein is only one example, and additional and/or different information may be stored therein. Moreover, various databases might be split or combined in accordance with any of the embodiments described herein. For example, the state rules database might be incorporated with the segmentation engine 2514.

Referring to FIG. 26, a table is shown that represents the WC insurance claim database 2600 that may be stored at the workers' compensation reconciliation platform 2500 according to some embodiments. The table may include, for example, entries identifying insurance claims being processed in accordance with some embodiments described herein. The table may also define fields 2602, 2604, 2606, 2608, 2610, 2612 for each of the entries. The fields 2602, 2604, 2606, 2608, 2610, 2612 may, according to some embodiments, specify: a claim identifier 2602, an insurance type 2604, a jurisdiction 2606, a cause of injury 2608, benefit type 2610, and an amount owed 2612. The WC insurance claim database 2600 may be created and updated, for example, based on insurance claim information electrically received on a periodic basis.

The claim identifier 2602 may be, for example, a unique alphanumeric code identifying an insurance claim that has been submitted in connection with insurance policy. The insurance type 2604 may indicate the type of insurance associated with the claim and/or policy. For example, as illustrated in FIG. 26 the insurance claim having a claim identifier of “C_100004” is associated with “workers' compensation insurance.” The jurisdiction 2606 might indicate where the claim was made and/or where an injury occurred. The cause of injury 2608 might indicate what type of injury is associated with the insurance claim, and the benefit type 2610 may indicate the type of workers' compensation benefit associated with the insurance claim. The amount owed 2612 may be automatically calculated as appropriate based at least in part, according to some embodiments, one or more rules or logic associated with the jurisdiction 2606.

Thus, embodiments described herein may provide a complete solution to automate a WC payment calculation. The system may account for multiple potential scenarios, such as wage adjustments, benefit adjustments, over payment situations, multiple payees (such as those associated with an attorney or child support lien), various waiting period scenarios, employer salary continuation, etc. and how claims should be handled in each state. These components may help avoid the significant consequences of payment amount mistakes in WC. Moreover, embodiments may provide an accounting approach, treating a WC claim as a generator of “payable” transactions for every day of lost wages, and a cash transaction for every daily amount within a check that offsets this payable amount. Similar to an accounting software application, the payable transactions and cash transaction may be matched and offset, providing traceability and transparency to the periods in a claim that have a positive or negative balance. Further, embodiments may provide real time reconciliation. That is, when a claim is accessed it may be automatically reconciled. All payable amounts may be recalculated based on the latest facts of the claim, and the handler can immediately understand how changing the facts of the claim may alter the balance.

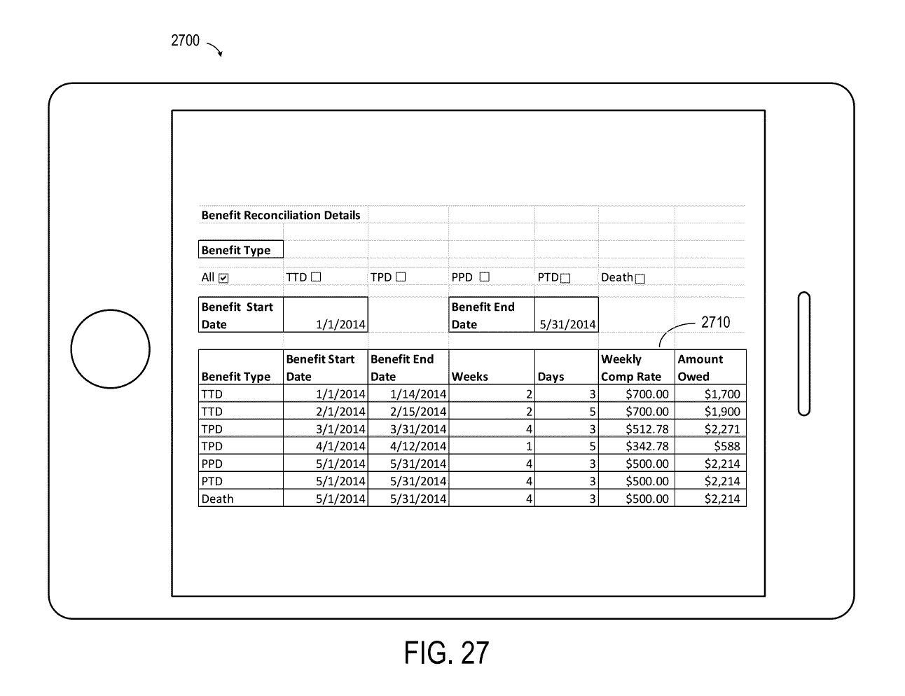

Applicants have discovered that embodiments described herein may be particularly useful in connection with the workers' compensation insurance policies described herein. Note, however, that other types of insurance may also be associated with embodiments described herein. Moreover, the displays illustrated with respect to the present FIGS. are only provided as examples, and embodiments may be associated with any other types of user interfaces. For example, FIG. 27 illustrates a tablet computer 2700 according to some embodiments. In particular, the tablet computer 2700 is displaying a benefit reconciliation details display 2710 similar to the one described with respect to FIG. 13.

Note that the present invention provides significant technical improvements to workers' compensation insurance claim processing. The present invention is directed to more than merely a computer implementation of a routine or conventional activity previously known in the industry as it significantly advances the technical efficiency, access and/or accuracy of workers' compensation insurance claim processing by implementing a specific new method and system as defined herein. The present invention is a specific advancement in the area of workers' compensation insurance claim processing by providing technical benefits in data accuracy, data availability and data integrity and such advances are not merely a longstanding commercial practice. The present invention provides improvement beyond a mere generic computer implementation as it involves the processing and conversion of significant amounts of data in a new beneficial manner as well as the interaction of a variety of specialized insurance, client and/or vendor systems, networks and subsystems. For example, in the present invention tens of thousands workers' compensation insurance claims may be analyzed and benefits may be accurately and automatically calculated.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A system for workers' compensation insurance claim processing, comprising:
a communication device to receive data indicative of a plurality of workers' compensation insurance claims submitted in connection with insurance policies along with an indication of a location associated with each insurance claim;
a computer storage unit for receiving, storing, and providing said data indicative of the plurality of insurance claims; and
a workers' compensation reconciliation platform processor in communication with the storage unit, wherein the processor is configured for:
for a first workers' compensation insurance claim associated with a first location, determining a first workers' compensation benefit rule,
for a second workers' compensation insurance claim associated with a second location, determining a second workers' compensation benefit rule different from the first workers' compensation benefit rule,
applying appropriate waiting period and retroactive period rules to the first and second workers' compensation insurance claims,
calculating a first benefit amount for the first workers' compensation insurance claim based on the first workers' compensation benefit rule and application of the waiting period and retroactive period rules,
calculating a second benefit amount for the second workers' compensation insurance claim based on the second workers' compensation benefit rule and application of the waiting period and retroactive period rules,
displaying a first reconciliation value representing a difference between the first benefit amount and an amount already paid in connection with the first workers' compensation insurance claim,
displaying a second reconciliation value representing a difference between the second benefit amount and an amount already paid in connection with the second workers' compensation insurance claim, and
transmitting indications of the first and second benefit amounts.

2. The system of claim 1, wherein the first and second workers' compensation benefit rules are associated with multiplier rules for benefit calculations, the multiplier rules being selected from a set of potential multiplier rules including at least two of: (i) a decimal percentage multiplier, (ii) a fraction multiplier, (iii) a combination of decimal percentage and fraction multipliers, (iv) a variable formula, (v) a variable formula based on a claimant's hourly wage, and (vi) a variable formula based on information about a claimant's dependents.

3. The system of claim 1, wherein the first and second workers' compensation benefit rules are associated with value rounding rules for benefit calculations.

4. The system of claim 3, wherein the value rounding rules for benefit calculations include at least two of: (i) a round up type, (ii) a round down type, (iii) a nearest rounding type, (iv) a no-rounding type, (v) a round to penny rule, (vi) a round to nickel rule, (vii) a round to quarter rule, and (viii) a round to dollar rule.

5. The system of claim 1, wherein the first and second workers' compensation benefit rules are associated with at least one of: (i) a benefit frequency, (ii) a minimum benefit amount, (iii) a maximum benefit amount, (iv) an overall benefit cap, (v) a layered benefit cap, (vi) a benefit waiting period, and (vii) a benefit waiting period type.

6. The system of claim 1 wherein the first and second workers' compensation benefit rules are associated with at least two of: (i) a 7 day work week definition, (ii) a 6 day work week definition, (iii) a 5 day work week definition, and (iv) a variable work week definition a claimant work schedule or business days of an employer.

7. The system of claim 1, wherein the indications of location comprise state identifiers.

8. The system of claim 1, wherein the workers' compensation reconciliation platform processor is further configured for:
dynamically arranging to provide and track payments of the first and second benefit amounts on a day-by-day basis.

9. The system of claim 1, wherein the system is further adapted to process insurance claims associated with: (i) automobile insurance, (ii) homeowners insurance, (iii) property insurance, (iv) general liability insurance, and (v) commercial insurance.

10. The system of claim 1, wherein the workers' compensation reconciliation platform processor is further configured for:
automatically transmitting indications of the first and second benefit amounts to at least one of: (i) an email server, (ii) a workflow application, (iii) a report generator, (iv) a calendar application, and (v) a payment facilitation device.

11. The system of claim 1, wherein the data indicative of the plurality of workers' compensation insurance claims is received via at least one of: (i) submitted paper claims, (ii) telephone call center operators, and (iii) an online claim submission web site.

12. The system of claim 1, wherein said calculations are performed by at least one of: (i) a payment wizard implemented via a spreadsheet application, and (ii) a standalone software application.

13. The system of claim 1, wherein the first and second benefit amounts are associated with at least one of: (i) a temporary total disablement, (ii) a temporary partial disablement, (iii) a permanent total disablement, (iv) a permanent partial disablement, (v) a death benefit, (vi) a supplemental income benefit, (vii) a permanent total supplemental benefit, (viii) a temporary income benefit, (ix) a partial temporary income benefit, (x) an impairment income benefit, (xi) a lifetime income benefit, and (xii) a death income benefit.

14. The system of claim 1, wherein the first and second benefit amounts are associated with at least one of: (i) temporary income benefits, (ii) partial temporary income benefits, (iii) impairment income benefits, (iv) supplemental income benefits, (v) lifetime income benefits, and (vi) disability insurance benefits.

15. A computer-implemented method associated with an insurance claim processing system, comprising:
receiving, by a communication device, data indicative of a plurality of workers' compensation insurance claims submitted in connection with insurance policies along with an indication of a location associated with each insurance claim;
storing, by a computer storage unit, said data indicative of the plurality of insurance claims along with an indication of a location associated with each insurance claim;
for a first workers' compensation insurance claim associated with a first location, determining, by a workers' compensation reconciliation platform processor, a first workers' compensation benefit rule;
for a second workers' compensation insurance claim associated with a second location, determining, by the workers' compensation reconciliation platform processor, a second workers' compensation benefit rule different from the first workers' compensation benefit rule;
applying, by the workers' compensation reconciliation platform processor, appropriate waiting period and retroactive period rules to the first and second workers' compensation insurance claims,
calculating, by the workers' compensation reconciliation platform processor, a first benefit amount for the first workers' compensation insurance claim based on the first workers' compensation benefit rule and application of the waiting period and retroactive period rules;
calculating, by a workers' compensation reconciliation platform processor, a second benefit amount for the second workers' compensation insurance claim based on the second workers' compensation benefit rule and application of the waiting period and retroactive period rules;
displaying a first reconciliation value representing a difference between the first benefit amount and an amount already paid in connection with the first workers' compensation insurance claim,
displaying a second reconciliation value representing a difference between the second benefit amount and an amount already paid in connection with the second workers' compensation insurance claim; and
transmitting indications of the first and second benefit amounts from the workers' compensation reconciliation platform processor to another device.

16. The method of claim 15, wherein the first and second workers' compensation benefit rules are associated with value rounding rules for benefit calculations.

17. The method of claim 15, wherein the first and second workers' compensation benefit rules are associated with at least one of: (i) a benefit frequency, (ii) a minimum benefit amount, (iii) a maximum benefit amount, (iv) a work week definition, (v) an overall benefit cap, a (vi) layered benefit cap, (vii) a benefit waiting period, and (viii) a benefit waiting period type.

18. The method of claim 15, wherein the workers' compensation reconciliation platform processor is further configured for:
dynamically arranging to provide and track payments of the first and second benefit amounts on a day-by-day basis.

19. The method of claim 15, further comprising:
automatically transmitting indications of the first and second benefit amounts to at least one of: (i) an email server, (ii) a workflow application, (iii) a report generator, (iv) a calendar application, and (v) a payment facilitation device.

20. The method of claim 15, wherein said calculations are performed by at least one of: (i) a payment wizard implemented via a spreadsheet application, and (ii) a standalone software application.

21. A system for workers' compensation insurance claim processing, comprising:
a communication device to receive data indicative of a plurality of workers' compensation insurance claims submitted in connection with insurance policies along with an indication of a location associated with each insurance claim;
a computer storage unit for receiving, storing, and providing said data indicative of the plurality of insurance claims; and
a workers' compensation reconciliation platform processor in communication with the storage unit, wherein the processor is configured for:
for a first workers' compensation insurance claim associated with a first location, determining a first value rounding rule,
for a second workers' compensation insurance claim associated with a second location, determining a second value rounding rule different from the first value rounding rule,
applying, by the workers' compensation reconciliation platform processor, appropriate waiting period and retroactive period rules to the first and second workers' compensation insurance claims,
calculating a first benefit amount for the first workers' compensation insurance claim based on the first value rounding rule and application of the waiting period and retroactive period rules,
calculating a second benefit amount for the second workers' compensation insurance claim based on the second value rounding rule and application of the waiting period and retroactive period rules,
displaying a first reconciliation value representing a difference between the first benefit amount and an amount already paid in connection with the first workers' compensation insurance claim,
displaying a second reconciliation value representing a difference between the second benefit amount and an amount already paid in connection with the second workers' compensation insurance claim, and
transmitting indications of the first and second benefit amounts.

22. The system of claim 21, wherein the workers' compensation reconciliation platform processor is further configured for:
dynamically arranging to provide and track payments of the first and second benefit amounts on a day-by-day basis.
